(19) United States
(12) Patent Application Publication
(10) Pub. No.: US 2017/0123605 A1
(43) Pub. Date: May 4, 2017

(54) METHOD AND ELECTRONIC DEVICE FOR DISPLAYING LIST CONTENTS

(71) Applicants: LE HOLDINGS (BEIJING) CO., LTD., Beijing (CN); LE SHI ZHI XIN ELECTRONIC TECHNOLOGY (TIAN JIN) LIMITED, Beijing (CN)

(72) Inventors: Jingbo SHU, Beijing (CN); Zheng ZHOU, Beijing (CN)

(21) Appl. No.: 15/243,256

(22) Filed: Aug. 22, 2016

Related U.S. Application Data
(63) Continuation of application No. PCT/CN2016/082639, filed on May 19, 2016.

(30) Foreign Application Priority Data
Nov. 2, 2015 (CN) 201510734649.0

(51) Int. Cl. G06F 3/0482; G06F 3/01

(52) U.S. Cl. CPC G06F 3/0482; G06F 3/012

(57) ABSTRACT

Some embodiments of the present disclosure provide a method and a device for displaying list contents applied to a headset apparatus including a display module, wherein the method includes: acquiring list contents, the list contents being composed of a plurality of sub-contents arranged according to an output sequence; displaying one sub-content in the list contents in a first display area of the display module; detecting the motion parameter of the rotation of the headset apparatus; and displaying the previous sub-content or next sub-content of the currently displayed sub-content of the first display area in the first display area when the headset apparatus is moved from a first position to a second position. Some embodiments of the present disclosure increase the operation convenience and improve the operation efficiency.

### CROSS-REFERENCE TO RELATED APPLICATIONS

This application is a continuation of PCT international application No. PCT/CN2016/082639, filed May 19, 2016, which claims priority to Chinese Patent Application No. 201510734649.0, filed Nov. 2, 2015, the entire contents of which are incorporated herein by reference.

### TECHNICAL FIELD

This relates to the field of electronic technologies, and, more particularly, to a method and a device for displaying list contents.

### BACKGROUND

A headset apparatus refers to a wearable smart device that can be worn on a user head, such as a virtual reality helmet, smart glasses, or the like, and the user may view contents displayed through the headset apparatus through wearing the headset apparatus.

When using the headset apparatus, it is needed to wear the headset apparatus on the user head. However, the current operation on the headset apparatus is still implemented through physical keys in the headset apparatus or a remote control apparatus, which is very inconvenient to operate. When contents displayed are list contents particularly, all the contents in the list cannot be completely displayed due to the limitation of the display area of the headset apparatus, and it is needed to frequently switch the contents in the list so that different contents in the list can be viewed. While the prior art can only implement to view different contents in the list through the physical keys or the remote control apparatus, which will be not only inconvenient to operate, but also affect the operating efficiency.

### SUMMARY

Some embodiments of the present disclosure provide a method and a device for displaying list contents, for solving the technical problems of inconvenient operation of the headset apparatus and low efficiency in the prior art.

Some embodiments of the present disclosure provide a method for displaying list contents applied to a headset apparatus, the headset apparatus including a display module, wherein the method includes:

acquiring list contents, the list contents being composed of a plurality of sub-contents arranged according to an output sequence;

displaying one sub-content in the list contents in a first display area of the display module;

detecting the motion parameter of the rotation of the headset apparatus; and

displaying the previous sub-content or next sub-content of the currently displayed sub-content of the first display area in the first display area when the headset apparatus is moved from a first position to a second position.

Some embodiments of the present disclosure provide an electronic device for displaying list contents applied to a headset apparatus, the headset apparatus including a display module, wherein the electronic device includes:

at least one processor; and

a memory communicably connected with the at least one processor for storing instructions executable by the at least one processor, wherein execution of the instructions by the at least one processor causes the at least one processor to:

acquire list contents, the list contents being composed of a plurality of sub-contents arranged according to an output sequence;

display one sub-content in the list contents in a first display area of the display module;

detect the motion parameter of the rotation of the headset apparatus; and

display the previous sub-content or next sub-content of the currently displayed sub-content of the first display area in the first display area when the headset apparatus is moved from a first position to a second position.

Some embodiments of the present disclosure provide a non-transitory computer-readable storage medium storing executable instructions that, when executed by an electronic device with a display, cause the electronic device to:

acquire list contents, the list contents being composed of a plurality of sub-contents arranged according to an output sequence;

display one sub-content in the list contents in a first display area of the display module;

detect the motion parameter of the rotation of the headset apparatus; and

display the previous sub-content or next sub-content of the currently displayed sub-content of the first display area in the first display area when the headset apparatus is moved from a first position to a second position.

The method and device for displaying list contents provided by some embodiments of the present disclosure display one sub-content in the list contents in the first display area of the display module of the headset apparatus, detect the motion parameter of the headset apparatus, and display the previous sub-content or next sub-content of the currently displayed sub-content of the first display area in the first display area when the headset apparatus is moved from the first position to the second position. Through some embodiments of the present disclosure, when wearing the headset apparatus, a user only needs to rotate the head to make the headset apparatus move so as to be capable of switching the contents in the display module; therefore, the operation is convenient and accurate, and the efficiency is high.

### BRIEF DESCRIPTION OF THE DRAWINGS

In order to explain the technical solutions in some embodiments of the disclosure or in the prior art more clearly, the drawings used in the descriptions of some embodiments or the prior art will be simply introduced hereinafter. It is apparent that the drawings described hereinafter are merely some embodiments of the disclosure, and those skilled in the art may also obtain other drawings according to these drawings without going through creative work.

FIG. 1 is a flow chart of one embodiment of a method for displaying list contents according to some embodiments of the present disclosure;

FIG. 2 is a flow chart of another embodiment of the method for displaying list contents according to some embodiments of the present disclosure;

FIGS. 3a˜3c are display schematic diagrams of a display module of a headset apparatus in some embodiments of the present disclosure respectively;

FIGS. 4a˜4c are another display schematic diagrams of the display module of the headset apparatus in some embodiments of the present disclosure respectively;

FIG. 5 is a structural schematic diagram of one embodiment of a device for displaying list contents according to some embodiments of the present disclosure;

FIG. 6 is a structural schematic diagram of another embodiment of the device for displaying list contents according to some embodiments of the present disclosure; and

FIG. 7 is a block diagram of an electronic device in accordance with some embodiments.

### DETAILED DESCRIPTION

To make the objects, technical solutions and advantages of some embodiments of the present disclosure more clearly, the technical solutions of the present disclosure will be clearly and completely described hereinafter with reference to some embodiments and drawings of the present disclosure. Apparently, some embodiments described are merely partial embodiments of the present disclosure, rather than all embodiments. Other embodiments derived by those having ordinary skills in the art on the basis of some embodiments of the disclosure without going through creative efforts shall all fall within the protection scope of the present disclosure.

The technical solutions of some embodiments of the present disclosure are mainly applied to a headset apparatus. The headset apparatus, for example, may be smart glasses, a virtual reality helmet, or the like. The headset apparatus usually includes two display modules which are corresponding to the left and right eyes of a user respectively. When the user is viewing the display modules of the headset apparatus, virtual reality display effects may be implemented. It should be illustrated that the display modules in some embodiments of the present disclosure may be a display apparatus including a display screen.

Although the headset apparatus may provide personalized services for the user, the operation of the headset apparatus still depends on physical key or remote control device at current, which is inconvenient to operate, and may cause inaccurate operation for the user immersed in virtual reality contents constructed by the headset apparatus.

Some embodiments of the present disclosure provide solutions mainly direct to the situation of displaying list contents by the headset apparatus.

The list contents are composed of a plurality of sub-contents usually, and the plurality of sub-contents have an output sequence. The inventor finds in studies that the sub-contents in the list contents cannot be completely displayed at the same time due to the size limitation of the display module of the headset apparatus, while the user mostly concerns an area in the display module that is most suitable for the user to view while viewing the display contents of the display module. Therefore, some embodiments of the present disclosure after acquiring the list contents to display, specifically display one sub-content in the list contents in the first display area of the display module, and may display the previous sub-content or next sub-content of the currently displayed sub-content of the first display area in the first display area according to the motion direction of the headset apparatus when detecting the rotation of the headset apparatus, i.e., the rotation of the user head driving the headset apparatus to move. Therefore, through some embodiments of the present disclosure, the user only needs to rotate the head to drive the headset apparatus to move so as to be capable of switching the contents in the display module; therefore, the operation is convenient and accurate, and the operation efficiency is high.

The technical solutions of the present disclosure will be described in details hereinafter with reference to the drawings.

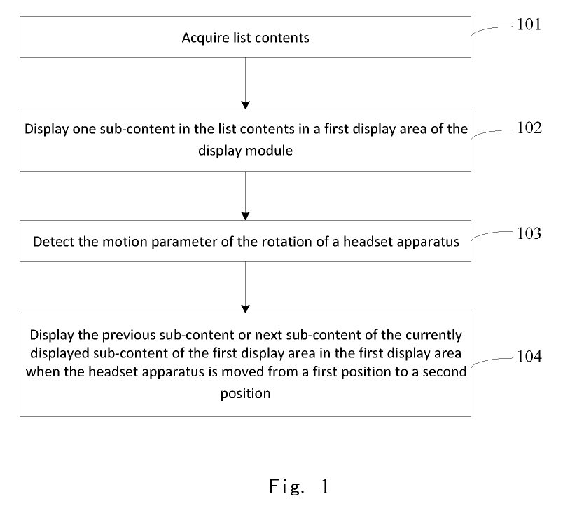

FIG. 1 is a flow chart of one embodiment of a method for displaying list contents provided by the embodiment of the present disclosure, which is specifically applied to a headset apparatus including a display module. During practical application, two display modules can be arranged specifically.

The method may include the several steps as follows.

In step 101: list contents are acquired, the list contents being composed of a plurality of sub-contents arranged according to an output sequence.

A plurality of sub-contents in the list contents are used for a user to select for viewing or operation.

The list contents, for instance, may be contents composed of a plurality of files, wherein each sub-content is namely one file, and the file may be a video file or the like. the list contents, for another instance, may be contents composed of a plurality of pictures, and each sub-content is namely one picture; the list contents, for another instance, may be contents composed of a plurality of text documents, and each sub-content is namely one text document; and the list contents, for another instance, may be contents composed of a plurality of webpages, and each sub-content is namely one webpage.

Due to the size limitation of the display module, all the contents of one webpage or one picture may possibly not be completely displayed in the display module at the same time, and only a part of the contents may be possibly displayed.

Therefore, as another probable implementation manner, the sub-contents in the list contents may also be as follows: the display contents like one webpage or one picture or the like are divided into a plurality of parts according to the size of a first display area in the display module, each part is namely one sub-content, and the webpage or the picture is namely served as the list contents including the plurality of sub-contents that are divided. For example, the list contents may be a picture; however, due to the size limitation of the first display area, a partial picture content can be displayed only; therefore, the picture may be divided into a plurality of sub-contents, each sub-content is a partial picture content, and the plurality of sub-contents form a complete picture content.

During practical application, film selection picture viewing and content searching, or the like, may be implemented through the list contents.

In step 102: one sub-content in the list contents is displayed in the first display area of the display module.

The first display area may be an area in the display module that is most suitable for the user to view, and is the middle area of the display area usually. Certainly, as another probable implementation manner, the first display area may particularly be the entire display area of the display module.

The sub-content may particularly be the sub-content displayed in the first display area when the headset apparatus is located at a first position.

In step 103: the motion parameter of the rotation of the headset apparatus is detected.

The headset apparatus is worn on the head, the rotation of the head may drive the headset apparatus to rotate, and the motion parameter may include motion direction, motion position, motion distance, time, or the like.

Wherein, the detection is conducted through a sensor in the headset apparatus concretely, for example, a gyroscope, an acceleration sensor, a displacement sensor, or the like.

When the user wears the headset apparatus, the rotation of the headset apparatus is caused by the rotation of the user head. Therefore, detecting the motion parameter of the rotation of the headset apparatus due to the rotation of the user head may concretely detecting the motion parameter of the rotation of the headset apparatus around the axis of the headset apparatus, and the axis may refer to any straight line parallel or vertical to a straight line where the user head is facing right ahead the body. In this way, the motion parameter of the headset apparatus may be correspondingly detected and acquired when the user head rotates to the left, to the right, downwards and upwards.

In step 104: the previous sub-content or next sub-content of the currently displayed sub-content of the first display area is displayed in the first display area when the headset apparatus is moved from a first position to a second position.

The first position may be any current position of the headset apparatus. As a probable implementation manner, the first position may refer to the current position of the headset apparatus keeping unchanged in a preset holding time, i.e., may be a position deemed to facilitate the user to view the display contents of the display module of the headset apparatus.

The second position namely refers to the position of the headset apparatus after moving relative to the first position.

The headset apparatus is moved from the first position to the second position; at this moment, the previous sub-content or next sub-content of the currently displayed sub-content of the first display area may be displayed in the first display area.

In the prior art, the switching of the sub-contents in the list contents can be only implemented through operating physical keys or a remote control apparatus, which is very inconvenient to operate. While in the embodiment of the present disclosure, when wearing the headset apparatus, the user only needs to rotate the head to drive the headset apparatus to move so as to be capable of switching the sub-contents in the list contents displayed in the first display area without operating physical keys or a remote control apparatus, so that the operation is convenient and efficient, and the accuracy is high.

Wherein, the position of the headset apparatus may concretely refer to the position of the display module, or the position of the central point of the headset apparatus, or the position of a reference point in the headset apparatus, wherein the reference point may be selected optionally.

The rotation of the user head includes left and right rotation as well as upward and downward rotation, so that the headset apparatus can implement left rotation, right rotation, upward rotation or downward rotation relative to the first position, so as to be moved to the second position.

During practical application, small amplitude head rotation may possibly occur to drive the headset apparatus to rotate when the user is wearing the headset apparatus; therefore, the operation accuracy may be improved through determination of preset conditions, so that the problem of sub-content switching caused by any motion of the headset apparatus can be avoided.

In order to improve the operation accuracy, as another embodiment, the displaying the previous sub-content or next sub-content of the currently displayed sub-content of the first display area in the first display area when the headset apparatus is moved from the first position to the second position may particularly include:

displaying the previous sub-content or next sub-content of the currently displayed sub-content of the first display area in the first display area when the headset apparatus is moved from the first position to the second position, and when the duration of stay in the second position is greater than a first predetermined duration and less than a second predetermined duration. The predetermined time is less than the preset reference time above.

That is, if the user wants to switch the sub-contents displayed in the first display area, the user may rotate the head to drive the headset apparatus to move to the second position, and when the duration of stay in the second position is greater than the first predetermined duration and less than the second predetermined duration, i.e., within the time greater than the first predetermined duration and less than the second predetermined duration, the headset apparatus is driven to rotate and recovered to the first position through rotating the head, so that the switching of the sub-contents in the first display area can be implemented.

When the first position refers to the current position of the headset apparatus, and the second position refers to a switched position after moving from the current position, after the user rotates the head to implement content switching, the second position is namely the current position of the headset apparatus. However, in order to facilitate viewing, the user cannot keep the headset apparatus at the second position; therefore, in order to improve the operation accuracy and avoid misoperation, the previous sub-content or next sub-content of the currently displayed sub-content of the first display area may be displayed in the first display area after the headset apparatus is moved from the first position to the second position, and is recovered from the second position to the first position after staying in the second position greater than the first predetermined duration and less than the second predetermined duration.

As another embodiment, the displaying the previous sub-content or next sub-content of the currently displayed sub-content of the first display area in the first display area when the headset apparatus is moved from the first position to the second position may particularly include:

displaying the previous sub-content or next sub-content of the currently displayed sub-content of the first display area in the first display area when the headset apparatus is moved from the first position to the second position, and when the distance between the first position and the second position is within a preset distance range, and the headset apparatus is recovered from the second position to the first position after being moved from the first position to the second position.

That is, if the user wants to switch the sub-contents displayed in the first display area, the user may rotate the head to drive the headset apparatus to move to the second position from the first position within a preset distance range, and drive the headset apparatus to recover from the second position to the first position after being moved to the second position, so that the switching of the sub-contents in the first display area can be implemented.

Wherein, in the embodiment, after the sub-contents displayed in the first display area are switched, the headset apparatus may be recovered to the first position through the rotation of the head, to facilitate viewing the currently displayed sub-contents of the first display area.

Certainly, as another embodiment, the previous sub-content or next sub-content of the currently displayed sub-content of the first display area may be displayed in the first display area when the headset apparatus is recovered from the second position to the first position after rotating from the first position to the second position, and when the distance between the first position and the second position is within a preset distance range, and when the duration of stay in the second position is greater than the first predetermined duration and less than the second predetermined duration.

Wherein, as another embodiment, the displaying the previous sub-content or next sub-content of the currently displayed sub-content of the first display area in the first display area when the headset apparatus is moved from the first position to the second position may particularly include:

displaying the previous sub-content of the currently displayed sub-content of the first display area in the first display area when the headset apparatus is moved from the first position to the second position and if the motion direction in the motion parameter is matched with the direction of the previous sub-content pointing to the currently displayed sub-content; and

displaying the next sub-content of the currently displayed sub-content of the first display area in the first display area if the motion direction in the motion parameter is matched with the direction of the next sub-content pointing to the currently displayed sub-content.

The matching may refer to same direction or direction angle difference in a preset error range.

Wherein, the headset apparatus is moved from the first position to the second position, and the previous sub-content or next sub-content of the currently displayed sub-content of the first display area may be displayed in the first display area after the preset conditions are satisfied, and the preset conditions may refer to the descriptions above, which will not be elaborated herein.

As another embodiment, the method, while displaying one sub-content in the list contents in the first display area of the display module, may also include:

displaying the prompting content of the previous sub-content of the currently displayed sub-content of the first display area in a second display area of the display module, and displaying the prompting content of the next sub-content of the currently displayed sub-content of the first display area in a third display area of the display module; wherein, the second display area, the first display area and the third display area are arranged in sequence. The display module may be at least divided into the first display area, the second display area and the third display area.

Through the prompting contents in the second display area and the third display area, the user may determine the motion direction of the headset apparatus according to the sub-content to be switched, so as to rotate the head. The prompting content may either be the summary information of the sub-content, or a partial content in the sub-content.

Moreover, in order to improve the operation accuracy and help the user judge whether the headset apparatus may display the previous sub-content or next sub-content of the currently displayed sub-content of the first display area in the first display area, as another embodiment, a switching marker related to the position of the headset apparatus may also be displayed in the first display area of the display module. In order to not obstruct the user to view the displayedcontents, the switching marker may be displayed in the first display area of the display module after the headset apparatus is detected to be moved from still.

The position of the switching marker in the display module changes with the position change of the headset apparatus. The sub-contents in the display area to which the switching marker is moved are displayed in the first display area namely.

The switching marker is also moved from the third position to the fourth position accordingly when the headset apparatus is moved from the first position to the second position, or the like. The motion parameter of the switching marker may be determined according to the motion parameter of the headset apparatus, for instance, the motion direction of the switching marker is the same as the motion direction of the headset apparatus, the motion distance of the headset apparatus is proportional to the motion distance of the switching marker, or the like.

To be specific, the switching marker is located in the third position when the motion direction from the third position to the fourth position is corresponding to the motion direction from the first position to the second position, and when the headset apparatus is in the first position.

In this way, the user may adjust the rotation amplitude of the head according to the motion position of the switching marker, so that the switching marker can be located in an area where the sub-content to be switched locates.

The technical solutions of the present disclosure will be described hereinafter with reference to the display schematic diagram of the display module of the headset apparatus during practical application.

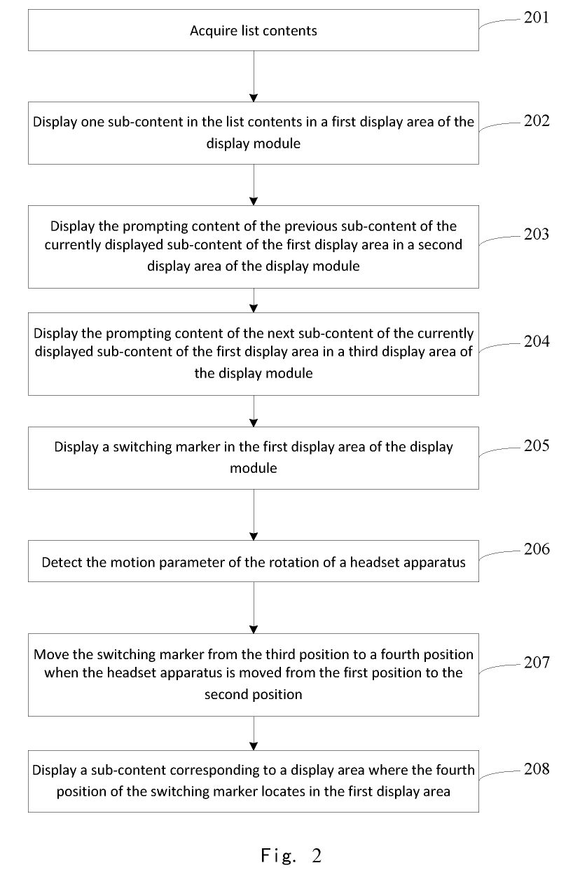

FIG. 2 is a flow chart of one embodiment of a method for displaying list contents provided by the embodiment of the present disclosure, which is specifically applied to a headset apparatus, the headset apparatus including a display module.

The method may include the several steps as follows.

In step 201: list contents are acquired, the list contents being composed of a plurality of sub-contents arranged according to an output sequence.

In step 202: one sub-content in the list contents is displayed in the first display area of the display module.

In step 203: the prompting content of previous sub-content of the currently displayed sub-content of the first display area is displayed in a second display area of the display module.

In step 204: the prompting content of next sub-content of the currently displayed sub-content of the first display area is displayed in the third display area.

Wherein, the second display area, the first display area and the third display area are arranged in sequence.

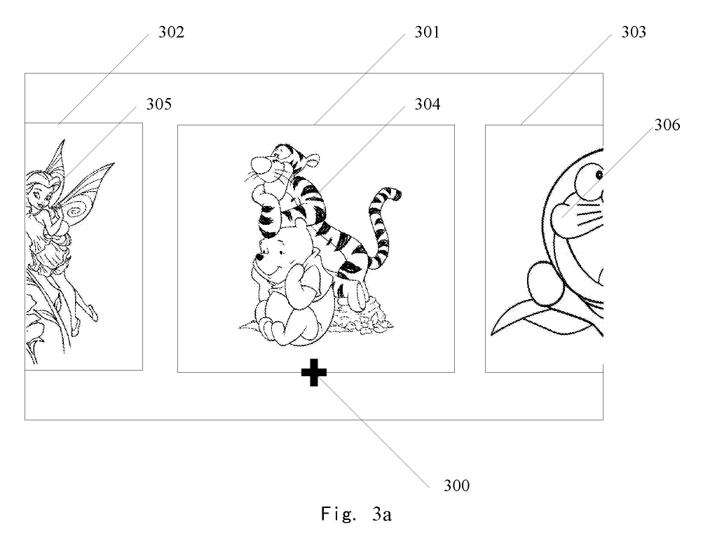

As a probable implementation manner, as shown in FIG. 3a, the display module may include a first display area 301, a second display area 302 and a third display area 303.

A sub-content 304 is displayed in the first display area 301; the prompting content of a sub-content 305, which may specifically be a partial content of the sub-content 305, is displayed in the second display area 302; and the prompting content of a sub-content 306, which may specifically be a partial content of the sub-content 306, is displayed in the second display area 303.

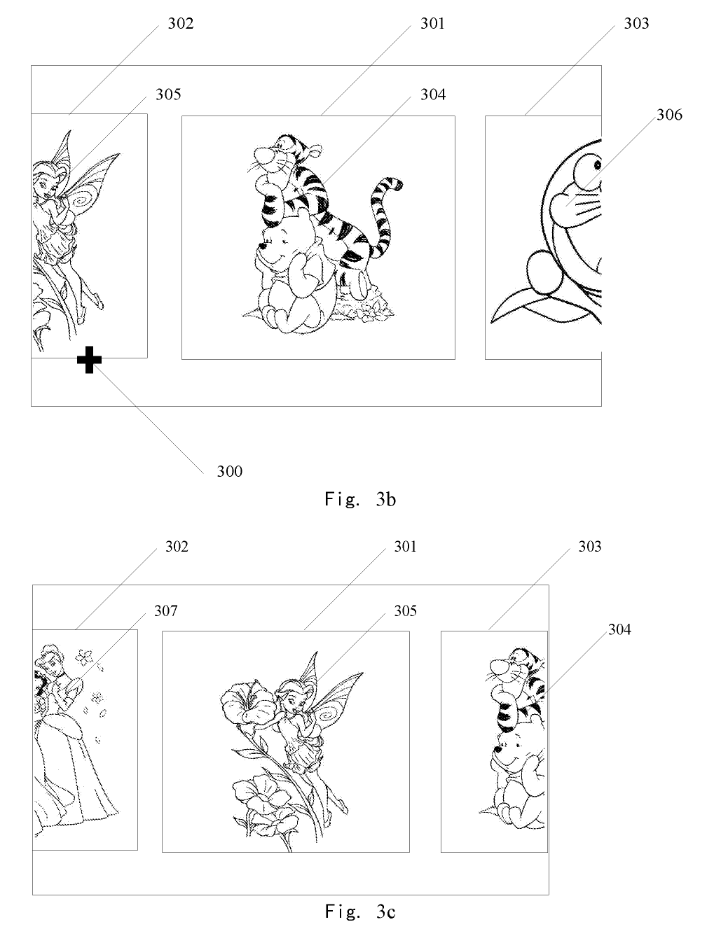

As another probable implementation manner, as shown in FIG. 4a, the display module may include a first display area 401, a second display area 402 and a third display area 403.

A sub-content 404 is displayed in the first display area 401; the prompting content of a sub-content 405, which may specifically be a partial content of the sub-content 405, is displayed in the second display area 402; and the prompting content of a sub-content 406, which may specifically be a partial content of the sub-content 406, is displayed in the second display area 403.

In step 205: a switching marker is displayed in the first display area of the display module.

The position of the switching marker is updated according to the motion of the headset apparatus.

The switching marker is located in the first display area, and the third position refers to a position in the first display area.

The position of the switching marker may be updated according to the motion of the headset apparatus.

In order to not influence the viewing of the user, the switching marker may be displayed in the first display area of the display module when the headset apparatus is detected to be moved from still, and may be displayed in a preset initial position.

The preset initial position may refer to any position in the first display area, and the third position is also namely the preset initial position.

While if the duration of stay of the headset apparatus in a certain position exceeds a certain duration, then the displaying of the switching marker may be cancelled.

As shown in FIG. 3a, a switching marker 300 is displayed in the first display area 301; and as shown in FIG. 4a, a switching marker 400 is displayed in the first display area 401.

In step 206: the motion parameter of the rotation of the headset apparatus is detected.

In step 207: the switching marker is moved from the third position to a fourth position according to the motion direction in the motion parameter when the headset apparatus is moved from the first position to the second position.

The position of the switching marker is updated according to the motion of the headset apparatus. When the headset apparatus is moved from the first position to the second position, the switching marker is also moved from the third position to the fourth position namely according to the motion direction in the motion parameter.

The third position is the current position of the switching marker.

Please refer to FIG. 3b and FIG. 4b.

When the user head is under a normal state, the user may rotate the head to the left, to the right, upwards or downwards; therefore, through the four directions of rotation of the user head, two different division manners of the first display area, the second display area and the third display area are as shown in FIGS. 3a˜3b and FIGS. 4a˜4b.

In FIGS. 3a˜3b, the user may rotate the head to the left or right to drive the headset apparatus to move, so that the switching marker may move towards the second display area or the third display area.

In FIGS. 4a˜4b, the user may rotate the head upwards or downwards to drive the headset apparatus to move, so that the switching marker may be moved towards the second display area or the third display area.

The user may adjust the rotation amplitude of the head according to the motion position of the switching marker, so that the switching marker may be moved to the second display area or the third display area.

In step 208: a sub-content corresponding to the display area where the fourth position of the switching marker locates is displayed in the first display area.

After the sub-content corresponding to the display area where the fourth position of the switching marker locates is displayed in the first display area, the prompting content of the previous sub-content of the currently displayed sub-content of the first display area is displayed in the second display area of the display module, and the prompting content of the next sub-content of the currently displayed sub-content of the first display area is displayed in the third display area of the display module.

Wherein, in order to facilitate the user to confirm the sub-content corresponding to the display area where the fourth position of the switching marker locates, a prompt message may also be outputted; for example, marking such as changing the outline color of the area may be performed on the display area of the sub-content corresponding to the display area where the fourth position of the switching marker locates.

The corresponding sub-content of the display area to which the switching marker is moved may be switched to the first display area for displaying. As shown in FIG. 3c, the fourth position is located in the second display area 302, i.e., the sub-content 305 in the second display area 302 is displayed in the first display area 301. Meanwhile, the prompting content of the previous sub-content 307 of the sub-content 305 is displayed in the second display area 302 namely, and the prompting content of the sub-content 304 is displayed in the third display area 303 namely.

As shown in FIG. 4c, the fourth position is located in the third display area 403, i.e., the sub-content 406 of the third display area is displayed in the first display area 401. Meanwhile, the prompting content of the sub-content 404 is displayed in the second display area 402 namely, and the prompting content of the next sub-content 407 of the sub-content 406 is displayed in the third display area 403 namely.

At this moment, the prompting content of the previous sub-content of the currently displayed sub-content of the first display area may be displayed in the second display area of the display module, and the prompting content of the next sub-content of the currently displayed sub-content of the first display area may be displayed in the third display area of the display module according to the sub-contents currently displayed in the first display area.

In the embodiment of the present disclosure, the detection of the motion parameter of the headset apparatus may be performed in real time, and the position of the switching marker in the display area is updated according to the motion of the headset apparatus.

Wherein, the displaying the sub-content corresponding to the display area where the fourth position of the switching marker locates in the first display area may include:

displaying the sub-contents corresponding to the second display area or the third display area where the fourth position of the switching marker locates in the first display area when the duration of stay of the headset apparatus in the second position is greater than the first predetermined duration and less than the second predetermined duration;

or, displaying the sub-content corresponding to the display area where the fourth position of the switching marker locates in the first display area when the headset apparatusis recovered from the second position to the first position after being moved from the first position to the second position, and when the duration of stay in the second position is greater than the first predetermined duration and is less than the second predetermined duration; or, displaying the sub-content corresponding to the display area where the fourth position of the switching marker locates in the first display area when the headset apparatus is recovered from the fourth position to the third position after being moved from the third position to the fourth position, and when the duration of stay in the fourth position is greater than the first predetermined duration and is less than the second predetermined duration;

or, displaying the sub-content corresponding to the display area where the fourth position of the switching marker locates in the first display area when the distance between the first position and the second position of the headset apparatus is within a preset distance range, and when the headset apparatus is recovered from the second position to the first position after being rotated from the first position to the second position, or when the third position and the fourth position of the switching marker are located in different display areas, and the switching marker is recovered from the fourth position to the third position after being rotated from the third position to the fourth position, or when the headset apparatus is recovered from the second position to the first position after being rotated from the first position to the second position, and when the third position and the fourth position of the switching marker are located in different display areas;

or, displaying the sub-content corresponding to the display area where the fourth position of the switching marker locates in the first display area when the distance between the first position and the second position of the headset apparatus is within a preset distance range, and when the duration of stay in the second position is greater than the first predetermined duration and less than the second predetermined duration, or when the third position and the fourth position of the switching marker are located in different display areas, and when the duration of stay of the switching marker in the fourth position is greater than the first predetermined duration and less than the second predetermined duration. In this case, the method, after the displaying the sub-content corresponding to the display area where the fourth position of the switching marker locates in the first display area, may also include: recovering the switching marker to the third position.

In the embodiment of the present disclosure, the user may switch among the sub-contents in the list contents displayed by the headset apparatus through rotating the head, which is convenient to operate, can improve the content switching efficiency, and improve the operation accuracy.

Moreover, the switching marker may also be displayed in the display module, so as to help the user judge whether the motion parameter of the headset apparatus satisfies the preset conditions, so that the successful rate of operation can also be improved.

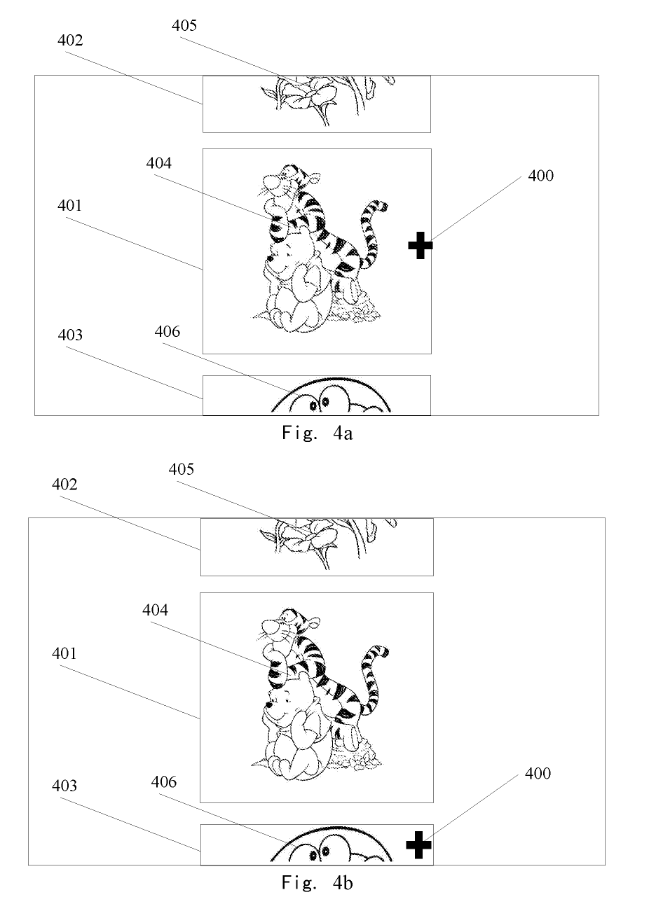

FIG. 5 is a structural schematic diagram of one embodiment of a device for displaying list contents provided by the embodiment of the present disclosure. The device is specifically applied to a headset apparatus, the headset apparatus including a display module, wherein the device may include:

an acquisition unit 501 configured to acquire list contents, the list contents being composed of a plurality of sub-contents arranged according to an output sequence;

a first display unit 502 configured to display one sub-content in the list contents in a first display area of the display module;

a detection unit 503 configured to detect the motion parameter of the rotation of the headset apparatus; and

a second display unit 504 configured to display the previous sub-content or next sub-content of the currently displayed sub-content of the first display area in the first display area when the headset apparatus is moved from a first position to a second position.

In the embodiment of the present disclosure, a user when wearing the headset apparatus only needs to rotate the head to drive the headset apparatus to move so as to be capable of switching the sub-contents in the list contents displayed in the first display area without operating physical keys or a remote control apparatus, so that the operation is convenient and efficient, and the accuracy is high.

As another embodiment, the second display unit may be specifically configured to:

display the previous sub-content or next sub-content of the currently displayed sub-content of the first display area in the first display area when the headset apparatus is moved from the first position to the second position and recovered from the second position to the first position after being moved from the first position to the second position, and when the duration of stay in the second position is greater than a first predetermined duration and is less than a second predetermined duration.

As another embodiment, the second display unit may be specifically configured to:

display the previous sub-content or next sub-content of the currently displayed sub-content of the first display area in the first display area when the distance between the first position and the second position is within a preset distance range, and the headset apparatus is recovered from the second position to the first position after being moved from the first position to the second position.

As another embodiment, the second display unit may be specifically configured to:

display the previous sub-content or next sub-content of the currently displayed sub-content of the first display area in the first display area when the distance between the first position and the second position is within a preset distance range, and the headset apparatus is recovered from the second position to the first position after being moved from the first position to the second position, and when the duration of stay in the second position is greater than a first predetermined duration and is less than a second predetermined duration.

As another embodiment, the second display unit may be specifically configured to:

display the previous sub-content of the currently displayed sub-content of the first display area in the first display area when the headset apparatus is moved from the first position to the second position, the headset apparatus satisfies preset conditions, and if the motion direction in the motion parameter is matched with the direction of the previous sub-content pointing to the currently displayed sub-content; and

display the next sub-content of the currently displayed sub-content of the first display area in the first display area if the motion direction in the motion parameter is matched with the direction of the next sub-content pointing to the currently displayed sub-content.

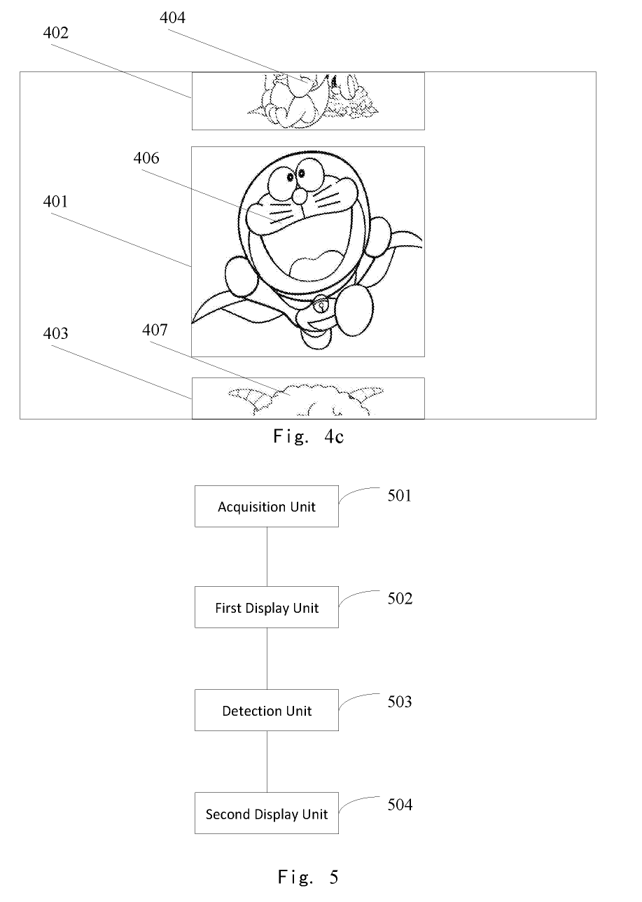

As another embodiment as shown in FIG. 6, the device, different from the embodiment as shown in FIG. 5, may also include:

a third display unit 505 configured to display the prompting content of the previous sub-content of the currently displayed sub-content of the first display area in a second display area of the display module, and display the prompting content of the next sub-content of the currently displayed sub-content of the first display area in a third display area of the display module; and

the first display unit 502, while displaying one sub-content in the list contents in the first display area of the display module, is also configured to trigger the third display unit; and

the second display unit 503, while displaying the previous sub-content or next sub-content of the currently displayed sub-content of the first display area in the first display area, is also configured to trigger the third display unit.

Moreover, in order to improve the operation accuracy, as another embodiment as described in FIG. 6, the device may also include a fourth display unit 506 and a position updating unit 507.

The fourth display unit 506 is configured to display a switching marker in the display module.

The switching marker may be displayed in the first display area, the second display area or the third display area, may be displayed in the display module when the headset apparatus is detected to be moved from still, and may be displayed in a preset initial position.

The third position of the switching marker in the display module may be the preset initial position.

The position updating unit 507 is configured to move the switching marker from the third position to a fourth position when the headset apparatus is moved from the first position to the second position.

The second display unit 504 may be specifically configured to:

display the sub-content corresponding to a display area where the fourth position of the switching marker locates in the first display area when the headset apparatus is moved from the first position to the second position.

In this way, a user may adjust the rotation amplitude of head according to the moving position of the switching marker, so that the switching marker is moved, and located in an area where the sub-content to be switched locates.

In order to improve the switching accuracy of the contents, the preset conditions may have various probable implementation manners, and are thus served as a probable implementation manner.

The second display unit 504 may be specifically configured to display the sub-content corresponding to the display area where the fourth position of the switching marker locates in the first display area when the headset apparatus is moved from the first position to the second position and recovered from the second position to the first position after being moved from the first position to the second position, and when the duration of stay in the second position is greater than a first predetermined duration and is less than a second predetermined duration.

As another probable implementation manner, the second display unit 504 may be specifically configured to display the sub-content corresponding to the display area where the fourth position of the switching marker locates in the first display area when the headset apparatus is moved from the first position to the second position, and when the distance between the first position and the second position of the headset apparatus is within a preset distance range, and when the headset apparatus is recovered from the second position to the first position in a predetermined time after being moved from the first position to the second position, or when the headset apparatus is recovered from the second position to the first position within the predetermined time after being moved from the first position to the second position, and when the third position and the fourth position of the switching marker are located in different display areas.

As another probable implementation manner, the second display unit 504 may be specifically configured to display the sub-content corresponding to the display area where the fourth position of the switching marker locates in the first display area when the headset apparatus is moved from the first position to the second position, and the third position and the fourth position of the switching marker are located in different display areas, and when the duration of stay in the four position is greater than the first predetermined duration or less than the second predetermined duration. In this case, the position updating unit is also configured to recover the switching marker to the third position after displaying the sub-content corresponding to the display area where the fourth position of the switching marker locates in the first display area.

Wherein, the first position may refer to the current position of the headset apparatus or may be a preset reference position. When the first position is a preset reference position and the headset apparatus is located in the first position, the switching marker is located in the first display area, and the corresponding third position thereof may be any position in the first display area.

The embodiment of the present disclosure also provides a headset apparatus including the device for displaying list contents according to any one of the foregoing embodiments. Through the headset apparatus of the embodiment of the present disclosure, a user may implement interactions among the sub-contents in the list conveniently, quickly and accurately through rotating the head only, so that the user experience is greatly improved.

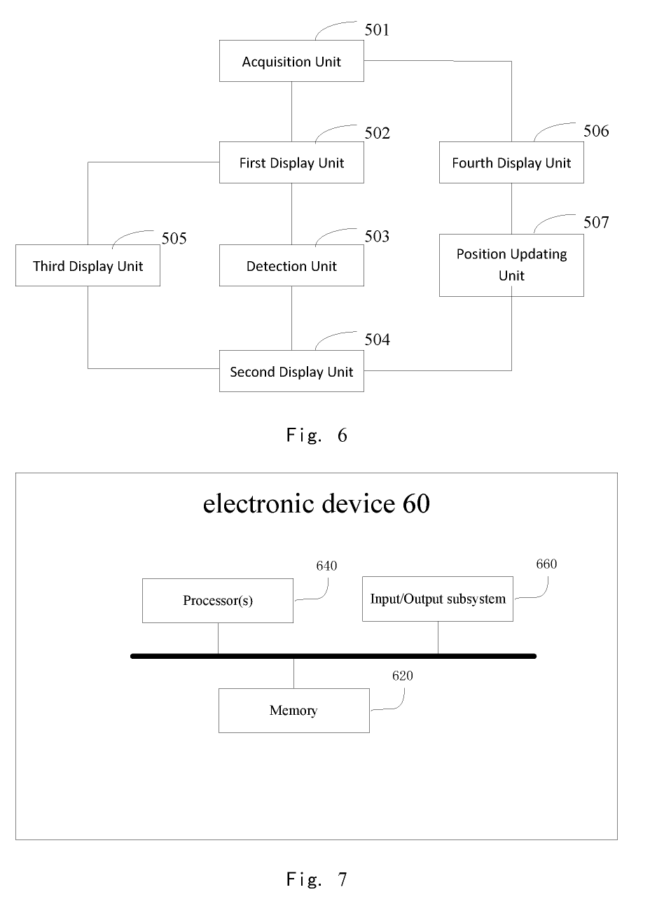

Attention is now directed toward embodiments of an electronic device. FIG. 7 is a block diagram illustrating an electronic device 60. The electronic device may include memory 620 (which may include one or more computer readable storage mediums), at least one processor 640, and input/output subsystem 660. These components may communicate over one or more communication buses or signal lines. It should be appreciated that the electronic device 60 may have more or fewer components than shown, may combine two or more components, or may have a different configuration or arrangement of the components. The various components may be implemented in hardware, software, or a combination of both hardware and software.

The memory 620, as a non-volatile computer readable storage medium, may be configured to store non-volatile software programs, non-volatile computer executable programs and modules, for example, the program instructions/modules corresponding to the method for displaying list contents in some embodiments of the present application. The non-volatile software programs, instructions and modules stored in the memory 620, when being executed, cause the processor 610 to perform various function applications and data processing, that is, performing the method for displaying list contents in the above method embodiments.

The memory 620 may also include a program storage area and a data storage area. The program storage area may store an operating system and an application implementing at least one function. The data storage area may store data created according to use of the device for displaying list contents. In addition, the memory 620 may include a high speed random access memory, or include a non-volatile memory, for example, at least one disk storage device, a flash memory device, or another non-volatile solid storage device. In some embodiments, the memory 620 optionally includes memories remotely configured relative to the at least one processor 610. These memories may be connected to the device for displaying list contents over a network. The above examples include, but not limited to, the Internet, Intranet, local area network, mobile communication network and a combination thereof.

One or more modules are stored in the memory 620, and when being executed by the one or more processors 610, perform the method for displaying list contents in any of the above method embodiments.

The product may perform the method according to some embodiments of the present application, has corresponding function modules for performing the method, and achieves the corresponding beneficial effects. For technical details that are not illustrated in detail in this embodiment, reference may be made to the description of the methods according to some embodiments of the present application.

Moreover, executable instructions for performing various functions may be included in a non-transitory computer readable storage medium or other computer program product configured for execution by at least one processor. Some embodiments of the present invention also provide a non-transitory computer-readable storage medium storing executable instructions that, when executed by an electronic device with a display, cause the electronic device to perform the method as shown in FIG. 1 or FIG. 2.

The electronic device in some embodiments of the present application is practiced in various forms, including, but not limited to:

(1) a mobile communication device: which has the mobile communication function and is intended to provide mainly voice and data communications; such terminals include: a smart phone (for example, an iPhone), a multimedia mobile phone, a functional mobile phone, a low-end mobile phone or the like;
(2) an ultra mobile personal computer device: which pertains to the category of personal computers and has the computing and processing functions, and additionally has the mobile Internet access feature; such terminals include: a PDA, an MID, an UMPC device or the like, for example, an iPad;
(3) a portable entertainment device: which displays and plays multimedia content; such devices include: an audio or video player (for example, an iPod), a palm game machine, an electronic book, and a smart toy, and a portable vehicle-mounted navigation device;
(4) a server: which provides services for computers, and includes a processor, a hard disk, a memory, a system bus or the like; the server is similar to the general computer in terms of architecture; however, since more reliable services need to be provided, higher requirements are imposed on the processing capability, stability, reliability, security, extensibility, manageability or the like of the device; and
(5) another electronic device having the data interaction function.

The device embodiments described above are only exemplary, wherein the units illustrated as separation parts may either be or not physically separated, and the parts displayed by units may either be or not physical units, i.e., the parts may either be located in the same place, or be distributed on a plurality of network units. A part or all of the modules may be selected according to an actual requirement to achieve the objectives of the solutions in some embodiments. Those having ordinary skills in the art may understand and implement without going through creative work.

Through the above description of the implementation manners, those skilled in the art may clearly understand that each implementation manner may be achieved in a manner of combining software and a necessary common hardware platform, and certainly may also be achieved by hardware. Based on such understanding, the foregoing technical solutions essentially, or the part contributing to the prior art may be implemented in the form of a software product. The computer software product may be stored in a storage medium such as a ROM/RAM, a diskette, an optical disk or the like, and includes several instructions for instructing a computer apparatus (which may be a personal computer, a server, or a network apparatus so on) to execute the method according to each embodiment or some parts of some embodiments.

It should be finally noted that the above embodiments are only configured to explain the technical solutions of the present disclosure, but are not intended to limit the present disclosure. Although the present disclosure has been illustrated in detail according to the foregoing embodiments, those having ordinary skills in the art should understand that modifications can still be made to the technical solutions recited in various embodiments described above, or equivalent substitutions can still be made to a part of technical features thereof, and these modifications or substitutions will not make the essence of the corresponding technical solutions depart from the spirit and scope of the technical solutions of some embodiments of the present disclosure.

What is claimed is:

1. A method for displaying list contents, applied to a headset apparatus with a display module, wherein the method comprising:
acquiring list contents, the list contents being composed of a plurality of sub-contents arranged according to an output sequence;
displaying one sub-content in the list contents in a first display area of the display module;
detecting the motion parameter of the rotation of the headset apparatus; and
displaying the previous sub-content or next sub-content of the currently displayed sub-content of the first display area in the first display area when the headset apparatus is moved from a first position to a second position.

2. The method according to claim 1, wherein the method, while displaying one sub-content in the list contents in the first display area of the display module, further comprising:
displaying the prompting content of the previous sub-content of the currently displayed sub-content of the first display area in a second display area of the display module, and displaying the prompting content of the next sub-content of the currently displayed sub-content of the first display area in a third display area of the display module; and
the method, while displaying the previous sub-content or next sub-content of the currently displayed sub-content of the first display area in the first display area, further comprising:
displaying the prompting content of the previous sub-content of the currently displayed sub-content of the first display area in the second display area, and displaying the prompting content of the next sub-content of the currently displayed sub-content of the first display area in the third display area.

3. The method according to claim 2, wherein the method, after the displaying one sub-content in the list contents in the first display area of the display module, further comprising:
displaying a switching marker in the first display area of the display module;
the method, while the headset apparatus is moved from the first position to the second position, further comprising:
moving the switching marker from a third position to a fourth position, wherein the motion direction from the third position to the fourth position is corresponding to the motion direction from the first position to the second position, and the switching marker is located in the third position when the headset apparatus is in the first position; and
the displaying the previous sub-content or next sub-content of the currently displayed sub-content of the first display area in the first display area when the headset apparatus is moved from the first position to the second position comprises:
displaying a sub-content corresponding to a display area where the fourth position of the switching marker locates in the first display area when the headset apparatus is moved from the first position to the second position and the headset apparatus satisfies preset conditions.

4. The method according to claim 1, wherein the displaying the previous sub-content or next sub-content of the currently displayed sub-content of the first display area in the first display area when the headset apparatus is moved from the first position to the second position comprises:
displaying the previous sub-content of the currently displayed sub-content of the first display area in the first display area when the headset apparatus is moved from the first position to the second position, and if the motion direction in the motion parameter is matched with the direction of the previous sub-content pointing to the currently displayed sub-content; and
displaying the next sub-content of the currently displayed sub-content of the first display area in the first display area if the motion direction in the motion parameter is matched with the direction of the next sub-content pointing to the currently displayed sub-content.

5. The method according to claim 1, wherein the displaying the previous sub-content or next sub-content of the currently displayed sub-content of the first display area in the first display area when the headset apparatus is moved from the first position to the second position comprises:
displaying the previous sub-content or next sub-content of the currently displayed sub-content of the first display area in the first display area when the headset apparatus is moved from the first position to the second position and recovered from the second position to the first position after being moved from the first position to the second position, and when the duration of stay in the second position is greater than a first predetermined duration and is less than a second predetermined duration.

6. The method according to claim 3, wherein the displaying the sub-content corresponding to the display area where the fourth position of the switching marker locates in the first display area when the headset apparatus is moved from the first position to the second position comprises:
displaying the sub-content corresponding to the display area where the fourth position of the switching marker locates in the first display area when the headset apparatus is moved from the first position to the second position and recovered from the second position to the first position after being moved from the first position to the second position, and when the third position and the fourth position of the switching marker are located in different display areas.

7. An electronic device for displaying list contents, applied to a headset apparatus with a display module, comprising:
at least one processor; and
a memory communicably connected with the at least one processor for storing instructions executable by the at least one processor, wherein execution of the instructions by the at least one processor causes the at least one processor to:
acquire list contents, the list contents being composed of a plurality of sub-contents arranged according to an output sequence;
display one sub-content in the list contents in a first display area of the display module;
detect the motion parameter of the rotation of the headset apparatus; and
display the previous sub-content or next sub-content of the currently displayed sub-content of the first display area in the first display area when the headset apparatus is moved from a first position to a second position.

8. The electronic device according to claim 7, wherein the at least one processor is further caused to:
display the prompting content of the previous sub-content of the currently displayed sub-content of the first display area in a second display area of the display module, and display the prompting content of the next sub-content of the currently displayed sub-content of the first display area in a third display area of the display module; and
while displaying one sub-content in the list contents in the first display area of the display module, trigger the third display unit; and
while displaying the previous sub-content or next sub-content of the currently displayed sub-content of the first display area in the first display area, trigger the third display unit.

9. The electronic device according to claim 8, wherein the at least one processor is further caused to:
display a switching marker in the first display area of the display module;
move the switching marker from a third position to a fourth position while the headset apparatus is moved from the first position to the second position, wherein the motion direction from the third position to the fourth position is corresponding to the motion direction from the first position to the second position, and the switching marker is located in the third position when the headset apparatus is in the first position; and
display the sub-content corresponding to a display area where the fourth position of the switching marker locates in the first display area when the headset apparatus is moved from the first position to the second position.

10. The electronic device according to claim 7, wherein the step to display the previous sub-content or next sub-content of the currently displayed sub-content of the first display area in the first display area when the headset apparatus is moved from the first position to the second position comprises:
display the previous sub-content of the currently displayed sub-content of the first display area in the first display area when the headset apparatus is moved from the first position to the second position, and if the motion direction in the motion parameter is matched with the direction of the previous sub-content pointing to the currently displayed sub-content; and
display the next sub-content of the currently displayed sub-content of the first display area in the first display area if the motion direction in the motion parameter is matched with the direction of the next sub-content pointing to the currently displayed sub-content.

11. The electronic device according to claim 7, wherein the step to display the previous sub-content or next sub-content of the currently displayed sub-content of the first display area in the first display area when the headset apparatus is moved from the first position to the second position comprises:
display the previous sub-content or next sub-content of the currently displayed sub-content of the first display area in the first display area when the headset apparatus is moved from the first position to the second position and recovered from the second position to the first position after being moved from the first position to the second position, and when the duration of stay in the second position is greater than a first predetermined duration and is less than a second predetermined duration.

12. The electronic device according to claim 9, wherein the step to display the sub-content corresponding to the display area where the fourth position of the switching marker locates in the first display area when the headset apparatus is moved from the first position to the second position comprises:
display the sub-content corresponding to the display area where the fourth position of the switching marker locates in the first display area when the headset apparatus is moved from the first position to the second position and recovered from the second position to the first position after being moved from the first position to the second position, and when the third position and the fourth position of the switching marker are located in different display areas.

13. A non-transitory computer-readable storage medium storing executable instructions that, when executed by an electronic device, cause the electronic device to:
acquire list contents, the list contents being composed of a plurality of sub-contents arranged according to an output sequence;
display one sub-content in the list contents in a first display area of a display module of a headset apparatus;
detect the motion parameter of the rotation of the headset apparatus; and
display the previous sub-content or next sub-content of the currently displayed sub-content of the first display area in the first display area when the headset apparatus is moved from a first position to a second position.

14. The non-transitory computer-readable storage medium according to claim 13, wherein the electronic device is further caused to:
display the prompting content of the previous sub-content of the currently displayed sub-content of the first display area in a second display area of the display module, and display the prompting content of the next sub-content of the currently displayed sub-content of the first display area in a third display area of the display module; and
while displaying one sub-content in the list contents in the first display area of the display module, trigger the third display unit; and
while displaying the previous sub-content or next sub-content of the currently displayed sub-content of the first display area in the first display area, trigger the third display unit.

15. The non-transitory computer-readable storage medium according to claim 14, wherein the electronic device is further caused to:
display a switching marker in the first display area of the display module;
move the switching marker from a third position to a fourth position while the headset apparatus is moved from the first position to the second position, wherein the motion direction from the third position to the fourth position is corresponding to the motion direction from the first position to the second position, and the switching marker is located in the third position when the headset apparatus is in the first position; and
display the sub-content corresponding to a display area where the fourth position of the switching marker locates in the first display area when the headset apparatus is moved from the first position to the second position.

16. The non-transitory computer-readable storage medium according to claim 13, wherein the step to display the previous sub-content or next sub-content of the currently displayed sub-content of the first display area in the first display area when the headset apparatus is moved from the first position to the second position comprises:
display the previous sub-content of the currently displayed sub-content of the first display area in the first display area when the headset apparatus is moved from the first position to the second position, and if the motion direction in the motion parameter is matched with the direction of the previous sub-content pointing to the currently displayed sub-content; and
display the next sub-content of the currently displayed sub-content of the first display area in the first display area if the motion direction in the motion parameter is matched with the direction of the next sub-content pointing to the currently displayed sub-content.

17. The non-transitory computer-readable storage medium according to claim 13, wherein the step to display the previous sub-content or next sub-content of the currently displayed sub-content of the first display area in the first display area when the headset apparatus is moved from the first position to the second position comprises:
display the previous sub-content or next sub-content of the currently displayed sub-content of the first display area in the first display area when the headset apparatus is moved from the first position to the second position and recovered from the second position to the first position after being moved from the first position to the second position, and when the duration of stay in the second position is greater than a first predetermined duration and is less than a second predetermined duration.

18. The non-transitory computer-readable storage medium according to claim 17, wherein the step to display the sub-content corresponding to the display area where the fourth position of the switching marker locates in the first display area when the headset apparatus is moved from the first position to the second position comprises:
display the sub-content corresponding to the display area where the fourth position of the switching marker locates in the first display area when the headset apparatus is moved from the first position to the second position and recovered from the second position to the first position after being moved from the first position to the second position, and when the third position and the fourth position of the switching marker are located in different display areas.
